(19) United States
(12) Patent Application Publication
(10) Pub. No.: US 2020/0216109 A1
(43) Pub. Date: Jul. 9, 2020

(54) DETECTING A HAND ON A STEERING WHEEL USING A CONDUCTIVE COIL IN THE STEERING WHEEL

(71) Applicant: Byton North America Corporation, Santa Clara, CA (US)

(72) Inventors: Ken Bauer, Gilroy, CA (US); Dirk Abendroth, Mountain View, CA (US); Baharak Soltanian, Mountain View, CA (US); Randy Tsang, Daly City, CA (US)

(21) Appl. No.: 16/240,198

(22) Filed: Jan. 4, 2019

(51) Int. Cl. B62D 1/04; B62D 1/06; B62D 6/00

(52) U.S. Cl. CPC B62D 1/046; B62D 6/007; B62D 1/06

(57) ABSTRACT

A steering wheel assembly for a vehicle includes a steering wheel, a first conductive coil coupled to the steering wheel, a second conductive coil that magnetically interacts with the first conductive coil, and a detection circuit coupled to the second conductive coil. The detection circuit includes a first circuit to generate a first signal based on a change in inductance and a second circuit to generate a second signal based on the first signal, the second signal to allow detection of a hand on the steering wheel.

### TECHNICAL FIELD

Embodiments of the present disclosure relate generally to operating a vehicle. More particularly, embodiments of the disclosure relate to detecting a hand on a steering wheel of a vehicle.

### BACKGROUND

Powered components have been added to steering wheels of vehicles to control items, such as radio controls, telephone controls, and cruise control buttons. Given that a steering wheel of a vehicle rotates, it adds to the complexity of the vehicle to include a system for providing power to components that rotate with the steering wheel, such as telephone and entertainment system controls. Such systems typically include brushes and contacts, which potentially are subject to wear and failure. Assembling such systems adds to vehicle production costs.

Certain autonomous driving systems require the participation of the driver at certain intervals or in certain situations. If a detection system for that participation involves a powered sensor on the steering wheel rim, that would likely trigger the resulting complexity of the prior art systems that feed power to a rotating steering wheel to power components.

### SUMMARY

In one aspect, a steering wheel assembly for a vehicle includes a steering wheel, a first conductive coil coupled to the steering wheel, a second conductive coil that magnetically interacts with the first conductive coil, and a detection circuit coupled to the second conductive coil. The detection circuit includes a first circuit to generate a first signal based on a change in inductance and a second circuit to generate a second signal based on the first signal, the second signal to allow detection of a hand on the steering wheel.

In another aspect, a vehicle includes a dashboard and a steering wheel assembly coupled to the dashboard. The steering wheel assembly includes a steering wheel, a first conductive coil coupled to the steering wheel, a second conductive coil that magnetically interacts with the first conductive coil, and a detection circuit coupled to the second conductive coil. The detection circuit includes a first circuit to generate a first signal based on a change in inductance and a second circuit to generate a second signal based on the first signal, the second signal to allow detection of a hand on the steering wheel.

In yet another aspect, a method for detecting a hand on a steering wheel of a vehicle includes inducing a change in inductance in a second conductive coil magnetically coupled to a first conductive coil on the steering wheel, generating a first signal based on the induced change in inductance, and generating a second signal based on the first signal, the second signal to allow detection of a hand on the steering wheel.

### BRIEF DESCRIPTION OF THE DRAWINGS

Embodiments of the disclosure are illustrated by way of example and not limitation in the figures of the accompanying drawings in which like references indicate similar elements.

FIG. 1 is a top view of a vehicle according to one embodiment.

FIG. 2 illustrates a portion of an interior of the vehicle shown in FIG. 1 according to one embodiment.

FIG. 3 illustrates a portion of a steering wheel coupled to a detection circuit according to an aspect of the present disclosure.

FIG. 4A illustrates a portion of a steering wheel coupled to a detection circuit according to one embodiment.

FIG. 4B illustrates a portion of a steering wheel coupled to a detection circuit according to another embodiment.

FIG. 5 is a flow diagram of a process of detecting a hand on a steering wheel according to one embodiment.

### DETAILED DESCRIPTION

A steering wheel assembly of a vehicle includes a steering wheel having an embedded inductive coil. The embedded inductive coil magnetically interacts with a second coil of a resonant oscillator circuit via a magnetic field. When hands are placed on the steering wheel the resulting change in inductance is coupled to the resonant oscillator circuit and the frequency shift or the amplitude shift is detected yielding a circuit output corresponding to touch. Detection of the hands of the driver on the steering wheel of the vehicle using a powerless/passive scheme is disclosed which enables a system to monitor the driver's awareness in ADAS applications.

Advantageously, no active circuitry in the steering wheel is required. This allows the steering wheel to rotate without any electrical wire connections of any type. All the powered circuits which connect to the car system are placed in a fixed location (for example, the hub) close to the steering wheel. This approach will enable vehicles to detect the driver's hands on the steering wheel whenever the ADAS function is activated.

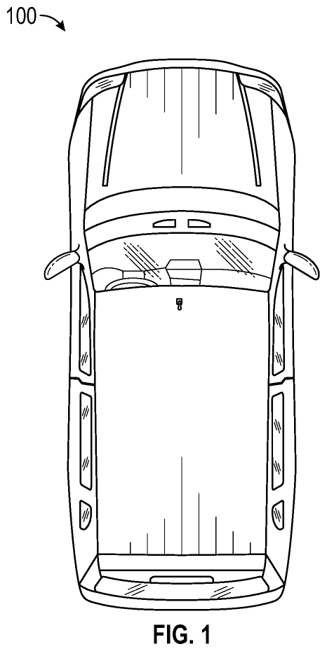

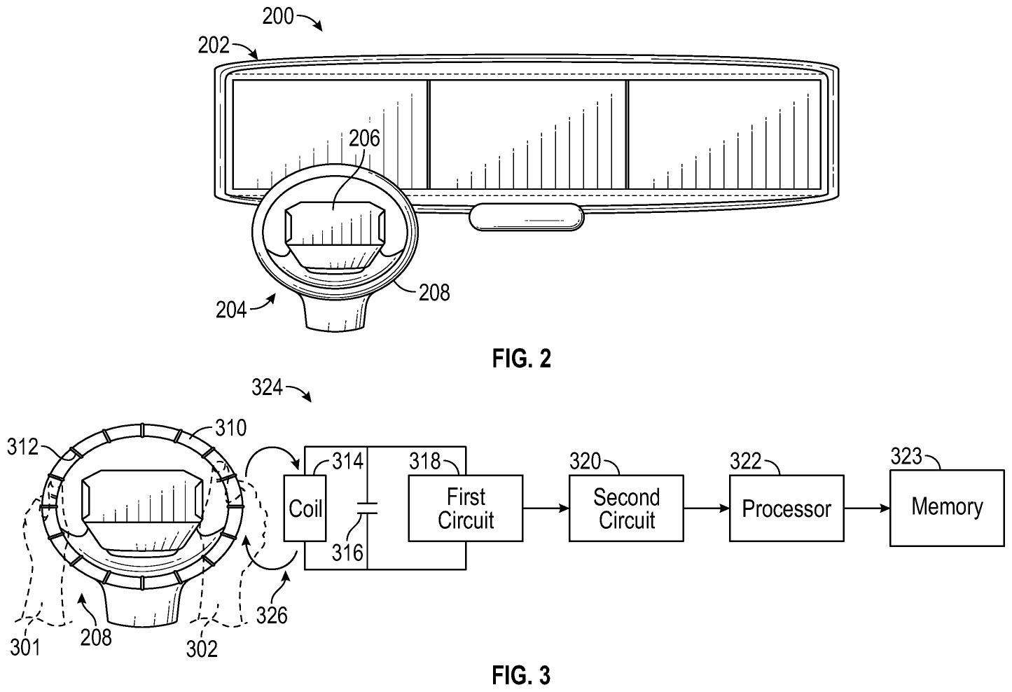

With reference to FIGS. 1-3, a vehicle 100 includes a dashboard 202 and a steering wheel assembly 204 coupled to dashboard 202. The steering wheel assembly 204 includes a hub 206 (also referred to as a center area 206), a steering wheel 208, a first conductive coil 312 coupled to steering wheel 208, a second conductive coil 314 that magnetically interacts with first conductive coil 312, and a detection circuit 324 coupled to second conducive coil 314. The detection circuit 324 includes a first circuit 318 to generate a first signal based on a change in inductance, and a second circuit 320 to generate a second signal based on the first signal. The second signal allows detection of a vehicle occupant's hand or hands on the steering wheel. For one embodiment, hub 206 is fixed and does not rotate with steering wheel 208; only the steering wheel rotates given that the wheel is connected to a rotating circle at the back of the hub. Hub 206 may contain detection circuit 324 and second conductive coil 314, both components embedded within the hub such that detection circuit 324 and second conductive coil 314 do not rotate with the steering wheel. Vehicle 100 may be any suitable vehicle such as an electric vehicle, a non-electric vehicle such as an internal combustion engine vehicle or a hybrid vehicle, a car, a truck, a sport utility vehicle (SUV), a van, a mini-van, a recreational vehicle (RV), a boat, an airplane, and the like.

With reference to FIG. 3, a portion of steering wheel assembly 204 is shown operatively coupled to detection circuit 324 and second conductive coil 314. A processor 322 of vehicle 100, in combination with a memory 323 having stored instructions or code, is also shown which receives the second signal of second circuit 320 and detects that a hand 301 is on steering wheel 208 based on the second signal. Processor 322 detects that one or more hands 301 and 302 have been placed on steering wheel 208 by a driver of vehicle 100. Processor 322 may suitably be a component of the vehicle's infotainment system or may be included in a different component of the vehicle's computer system.

The advanced driver-assistance system (ADAS) level 3 has a requirement for human intervention. System 324, by detecting one or more hands on steering wheel 208, can meet the requirement of ADAS level 3, when activated, of showing human intervention.

Continuing with FIG. 3, first conductive coil 312 is wound or wrapped around a rim structure 310 both of which are located inside steering wheel 208. The outer surface or component of steering wheel 208 has been removed to show the interior portion of steering wheel which includes rim structure 310 and first conductive coil 312. First conductive coil 312 may suitably include metal such as copper. Rim structure 310 may suitably include a non-conductive material such as plastic. Detection circuit 324 further includes a capacitor 316 coupled in parallel with second conductive coil 314. Second conductive coil 314 is magnetically coupled to first conductive coil 312 via magnetic field 326 when current flows through second conductive coil 314 when detection circuit 324 is powered. For one embodiment, first conductive coil 312 is proximate to second conductive coil 314 and a suitable distance between the two coils 312 and 314 may be approximately 4-5 millimeters. For one embodiment, first conductive coil 312 is embedded in steering wheel 208, as shown in FIG. 3. In another embodiment, first conductive coil 312 is a single conductive coil wrapped around rim structure 310 as also shown in FIG. 3.

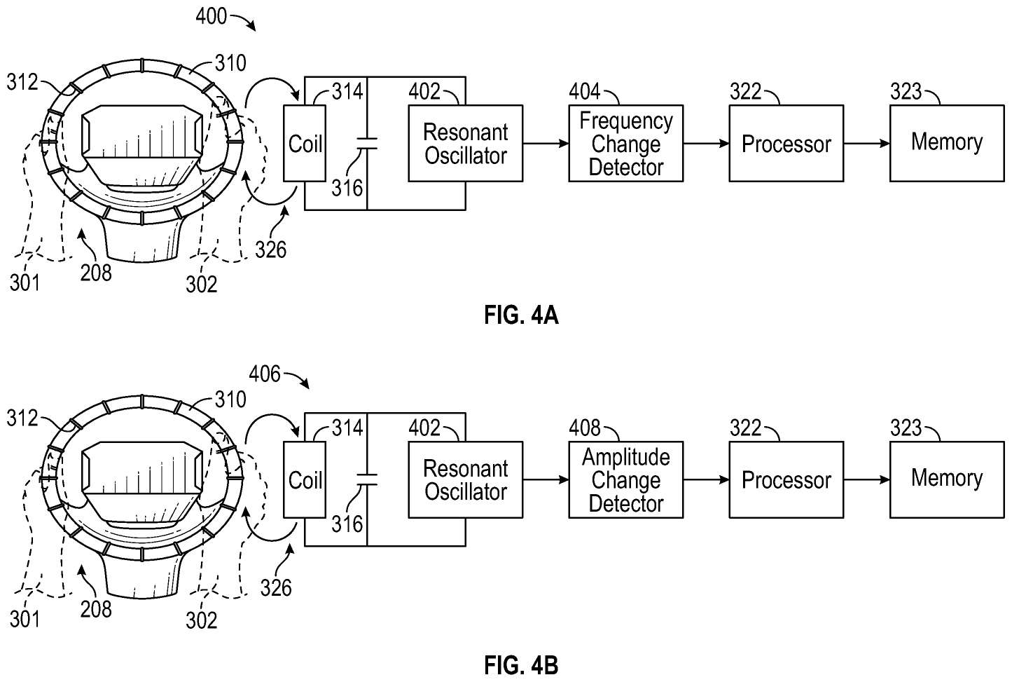

In accordance with another embodiment of the present disclosure, the first and second circuits of FIG. 3 may consist of a resonant oscillator 402 and a frequency change detector 402, respectively, as shown in FIG. 4A. Resonant oscillator 402 generates the first signal (for example, an oscillating signal outputted by the resonant oscillator) and frequency change detector 402 generates the second signal (for example, output of the frequency change detector) based on the first signal. First inductive coil 312 couples to second conductive coil 314 of resonant oscillator 402 via a magnetic field represented by 326.

Continuing with FIG. 4A, when one or more hands (not shown) of a person (for example, the driver of the vehicle) are placed on steering wheel 208, this placement of the one or more hands changes the impedance of first conductive coil 312 which results in a change in inductance coupled to resonant oscillator 402 and a frequency shift in the signal is detected by frequency change detector 404 corresponding to a touch of steering wheel 208 by the driver of the vehicle. The frequency shift (either an increase or decrease in frequency) in the signal outputted by frequency change detector 404 may be used by processor 322 to detect that one or more hands 301 and 302 have been placed on steering wheel 208 by a driver of the vehicle. This results in compliance with certain ADAS level 3 requirements discussed above whenever the ADAS function is activated in the vehicle. Processor 322 may compare the frequency shift in the signal outputted by frequency change detector 404 with a known reference frequency to determine that one or more hands have been placed on the steering wheel. For example, the known reference frequency may be the frequency of a signal when no hand or hands have been placed on the steering wheel.

For one aspect, steering wheel 208 is completely passive with no power and there is no active circuitry in the steering wheel. This allows the steering wheel to rotate without any electrical wire connections of any type. All the powered circuits (for example, the detection circuit) which connect to the vehicle's computer system are placed in a fixed location (for example, the hub) proximate to the steering wheel. An advantage of the present disclosure is that it is not easy to hack into, as opposed to other possible systems of monitoring driver control of the steering wheel. Another advantage is reducing the complexity of the connection to steering wheel 208.

In accordance with another embodiment of the present disclosure, the first and second circuits of FIG. 3 may consist of a resonant oscillator 402 and an amplitude change detector 408, respectively, as shown in FIG. 4B. With reference to FIG. 4B, another embodiment of the present disclosure is shown in which amplitude change detector 408 is used to allow the detection of one or more hands 301 and 302 on steering wheel 208. Amplitude change detector 408 generates a second signal based on a first signal outputted by resonant oscillator 402. When one or more hands 301 and 302 of a person (for example, the driver of the vehicle) are placed on steering wheel 208, this placement of the one or more hands 301 and 302 on the steering wheel changes the impedance of first conductive coil 312 which results in a change in inductance coupled to resonant oscillator 402 and an amplitude change in the signal is detected by amplitude change detector 408 corresponding to a touch of steering wheel 208 by the driver of the vehicle. The amplitude change (for example, an increase in amplitude) in the signal outputted by amplitude change detector 404 may be used by processor 322 to detect that one or more hands 301 and 302 have been placed on steering wheel 208 by a driver of the vehicle thus complying with certain ADAS level 3 requirements as discussed above whenever the ADAS function is activated in the vehicle. Processor 322 may compare the amplitude in the signal outputted by amplitude change detector 404 with a known reference amplitude to determine that one or more hands 301 and 302 have been placed on the steering wheel. For example, the known reference amplitude may be the amplitude (for example, 4 volts peak to peak) of a signal when no hand or hands have been placed on the steering wheel. For example, when one or more hands 301 and 302 have been placed on the steering wheel, the amplitude of the signal outputted by amplitude change detector may be approximately 8 volts peak to peak.

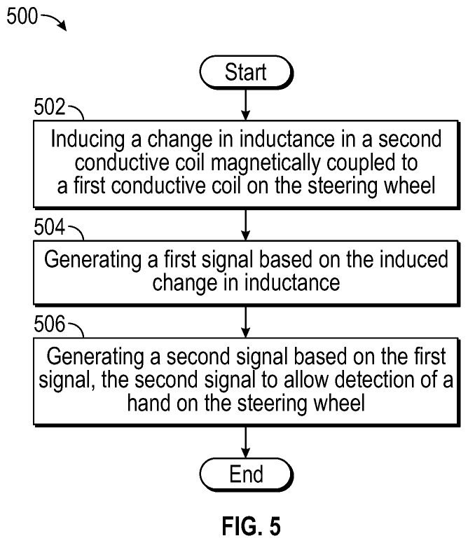

With reference to FIG. 5, a flow diagram 500 in accordance with an aspect of the present disclosure is shown. Flow diagram 500 illustrates a process for detecting a hand on a steering wheel of a vehicle which includes inducing a change in inductance in a second conductive coil magnetically coupled to a first conductive coil on the steering wheel at 502, generating a first signal based on the induced change in inductance at 504, and generating a second signal based on the first signal, the second signal to allow detection of a hand on the steering wheel at 506.

A computer-readable storage medium may also be used to store the some software functionalities described above persistently. While a computer-readable storage medium in an exemplary embodiment is a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media, or any other non-transitory machine-readable medium.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

Various embodiments and aspects of the disclosures are described with reference to details discussed herein, and the accompanying drawings illustrate the various embodiments. The description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrases “in one embodiment” or “for one embodiment” in various places in the specification do not necessarily all refer to the same embodiment.

What is claimed is:

1. A steering wheel assembly for a vehicle, the steering wheel assembly comprising:
a steering wheel;
a first conductive coil coupled to the steering wheel;
a second conductive coil that magnetically interacts with the first conductive coil;
a detection circuit coupled to the second conductive coil, the detection circuit comprising:
a first circuit to generate a first signal based on a change in inductance; and
a second circuit to generate a second signal based on the first signal, the second signal to allow detection of a hand on the steering wheel.

2. The steering wheel assembly of claim 1, further comprising a capacitor coupled in parallel with the second conductive coil.

3. The steering wheel assembly of claim 1, wherein the first circuit includes a resonant oscillator circuit to generate the first signal.

4. The steering wheel assembly of claim 3, wherein the second circuit includes a frequency change detector to generate the second signal based on the first signal.

5. The steering wheel assembly of claim 3, wherein the second circuit includes an amplitude change detector to generate the second signal based on the first signal.

6. The steering wheel assembly of claim 1, wherein the first conductive coil is proximate to the second conductive coil.

7. The steering wheel assembly of claim 6, wherein the first conductive coil is embedded in the steering wheel.

8. The steering wheel assembly of claim 7, wherein the first conductive coil is a single conductive coil.

9. A vehicle comprising:
a dashboard; and
a steering wheel assembly coupled to the dashboard, the steering wheel assembly comprising:
a steering wheel;
a first conductive coil coupled to the steering wheel;
a second conductive coil that magnetically interacts with the first conductive coil;
a detection circuit coupled to the second conductive coil, the detection circuit comprising:
a first circuit to generate a first signal based on a change in inductance; and
a second circuit to generate a second signal based on the first signal, the second signal to allow detection of a hand on the steering wheel.

10. The vehicle of claim 9, further comprising:
a processor to detect the hand on the steering wheel based on the second signal.

11. The vehicle of claim 10, further comprising a capacitor coupled in parallel with the second conductive coil.

12. The vehicle of claim 9, wherein the first circuit includes a resonant oscillator circuit to generate the first signal.

13. The vehicle of claim 12, wherein the second circuit includes a frequency change detector to generate the second signal based on the first signal.

14. The vehicle of claim 12, wherein the second circuit includes an amplitude change detector to generate the second signal based on the first signal.

15. The vehicle of claim 9, wherein the first conductive coil is proximate to the second conductive coil.

16. The vehicle of claim 15, wherein the first conductive coil is embedded in the steering wheel.

17. The vehicle of claim 16, wherein the first conductive coil is a single conductive coil.

18. A method for detecting a hand on a steering wheel of a vehicle, the method comprising:
inducing a change in inductance in a second conductive coil magnetically coupled to a first conductive coil on the steering wheel;
generating a first signal based on the induced change in inductance; and
generating a second signal based on the first signal, the second signal to allow detection of a hand on the steering wheel.

19. The method of claim 18, wherein the first signal is an oscillating signal.

20. The method of claim 19, wherein the second signal is a change in frequency of the first signal.
